(19) United States
(12) Patent Application Publication
(10) Pub. No.: US 2015/0019439 A1
(43) Pub. Date: Jan. 15, 2015

(54) Systems and Methods Relating to Secure Payment Transactions

(71) Applicant: MASTERCARD INTERNATIONAL INCORPORATED, Purchase, NY (US)

(72) Inventor: Simon Phillips, York (GB)

(21) Appl. No.: 14/330,227

(22) Filed: Jul. 14, 2014

(30) Foreign Application Priority Data
Jul. 15, 2013 (GB) 1312636.2
Jul. 18, 2013 (GB) 1312887.1

(51) Int. Cl. G06Q 20/38; G06Q 20/40

(52) U.S. Cl. CPC G06Q 20/382; G06Q 20/401; G06Q 2220/00
USPC 705/64; 705/39

(57) ABSTRACT

Systems and methods are provided for processing a transaction to enable an issuer of a physical transaction device to process a transaction message relating to a digital transaction device, where the digital transaction device is a digitized counterpart of the physical transaction device. In connection therewith, a transaction processing system is configured to receive the transaction message including a digital device data set associated with the digital transaction device; identify a physical device data set that corresponds to the digital device data set from a group of paired physical device data sets and respective digital device data sets; modify the transaction message to include the identified physical device data set to form a modified transaction message; and communicate the modified transaction message to the issuer of the physical transaction device.

### FIELD

The present disclosure relates to systems and methods for the creation and use of ‘electronic’ or ‘digital’ payment cards for use in digital payment transactions.

### BACKGROUND

When a user registers for a secure service, the service provider verifies that the user is genuine and legitimately registering for the service. For example, when the user registers (or “digitizes”) a physical payment card (such as contact or contactless integrated circuit chip card) with a digital wallet to create a digital card, the digitization service provider confirms that the actual user of the physical payment card is the person requesting the digitization service.

Aspects of the digital card stored in the digital wallet may be different to the equivalent aspects of the physical card, for example, the digital card may have a new card number and/or account number. The digital card is typically located on a payment device, such as a mobile phone with near field communication (NFC). The digital card enables the user to carry out payment transactions with Points of Interaction (POIs), for example, point of sale terminals with NFC.

The physical payment card is sent to the user by an issuer, typically a financial institution with whom the user has an account. The user may use the card to make payment transactions at point of sale devices located at merchants. The point of sale device reads the data held on the physical card, either on the magnetic stripe or, if the card is of the ‘chip and pin’ type, a chip integrated within the card, and generates a financial transaction. In this context the financial transaction may be a payment transaction seeking authorization for the amount of the transaction, or it may be a refund transaction, for example. The payment transaction is communicated by the merchant to a merchant acquirer which then routes the payment transaction to the issuer via the transaction processing entity for authorization. The issuer then carries out a series of checks to determine whether the user's credit is sufficient and to identify possible fraudulent transactions. If the checks are positive, the issuer then sends an appropriate authorization back to the acquirer to complete the authorization stage of the payment transaction. Typically, an issuer has a suitable infrastructure to handle payment transactions relating to the physical cards that it has issued to its users. However, with the emergence of the digitization of physical payment cards into digital payment card counterparts, issuers may not have an infrastructure that is suitable for processing payment transactions originating from such digital cards.

It is against this background that the present disclosure has been devised.

### SUMMARY

In one aspect, the disclosure relates to processing a transaction to enable an issuer of a physical transaction device to process a transaction message relating to a digital transaction device, wherein the digital transaction device is a digitized counterpart of the physical transaction device. An example method comprises:
receiving a transaction message including a digital device data set associated with the digital transaction device;
identifying a physical device data set that corresponds to the digital device data set from a group of paired physical device data sets and respective digital device data sets stored in a database associated with a transaction processing system;
modifying the transaction message to include the identified physical device data set to form a modified transaction message;
communicating the modified transaction message to the issuer of the physical transaction device.

The disclosure is also embodied in a non-transient computer readable medium containing program instructions for causing a computer to perform the above described method.

The disclosure may also be expressed as, and therefore also embraces, a system or processing platform for processing a transaction to enable an issuer of a physical transaction device to process a transaction message relating to a digital transaction device, wherein the digital transaction device is a digitized counterpart of the physical transaction device. The system comprises a transaction processing system configured to:
receive a transaction message including a digital device data set associated with the digital transaction device;
identify a physical device data set that corresponds to the digital device data set from a group of paired physical device data sets and respective digital device data sets stored in a database associated with the transaction processing system;
modify the transaction message to include the identified physical device data set to form a modified transaction message; and
communicate the modified transaction message to the issuer of the physical transaction device.

Advantageously, the present disclosure provides a scheme, be it expressed as a system, processing platform or a method, which enables an issuer, as a financial institution involved with issuing payment devices/cards, to process and authorise payment transactions relating to digitized payment cards even if the issuer only has the infrastructure to provide authorisation of payment transactions relating to physical payment cards. This is achieved by the transaction processing system in effect providing a mapping process that acts to ‘convert’ the digital device data set in the transaction message into a physical device data set that can be handled by the issuer. In effect, therefore, the transaction processing system acts as a secure ‘translator’ between other entities in a financial transaction network. This increases the flexibility of the transaction processing system and also increases the technical availability of digitized payment techniques to a wider network of issuers. The disclosure can therefore encourage take-up of EMV-type transaction processes in countries that have yet to perform large-scale roll out of suitable systems and protocols to card issuing organisations.

In order to enable the mapping process to take place, prior to the transaction being initiated, the physical device data set may be captured and then communicated to the transaction processing system, whereby it is then stored in a database and paired with a corresponding digital device data set already stored in the database.

In the illustrated embodiment, the capturing of the physical device data set includes a device reading apparatus, such as a payment card reader, that is configured to read the physical device data set from the physical transaction device and encrypting said data set.

To ensure that the data set is secure, in one embodiment the encryption of the physical device data set occurs before it is communicated to the transaction processing system. In this way, when the card reader is operated in conjunction with a mobile device, such as a mobile phone or a tablet, the data set is encrypted before it is sent through the mobile device.

In one embodiment, the card reader is configured to encrypt the physical device data set with a selected encryption item that is selected from a group of two or different encryption items. The specific encryption item to be used may be selected by way of a user interface of the card reader. Alternatively, or in addition, the card reader may further comprise a machine interface configured to interface with a computing device, and wherein the payment card reader is configured to allow selection into the first or second modes of operation via the machine interface.

In another aspect, the disclosure provides a payment card reader comprising: a receiving part for receiving a data storage unit of a payment card; a data capture module configured to capture physical card data from the data storage unit of the payment card; a first encryption item and at least a second encryption item, wherein, in a first mode of operation the payment card reader encrypts the captured physical card data using the first encryption item; and wherein, in a second mode of operation the payment card reader encrypts the captured physical card data using the second encryption item.

In the illustrated embodiment, to enable the card reader to operate in any of the plurality of modes, it may comprise a user interface configured to provide selection of the first or second modes of operation.

Alternatively, or in addition, the card reader may further comprise a machine interface configured to interface with a computing device, wherein the payment card reader is configured to allow selection into the first or second modes of operation via the machine interface.

Although it is envisaged that different encryption keys will be used based on a single encryption algorithm, it is possible for different encryption algorithms to be selected. The term encryption ‘item’ shall therefore be understood to mean an encryption key or algorithm.

The card reader device may include three or more modes of operation to allow for a wider range of encryption items/keys to be used in conjunction with a correspondingly wide range of functions.

Expressed another way, the disclosure provides a data reading device for reading data from a data carrier such as a payment card, the device being operable in one of a plurality of operational modes, and wherein the device is configured to select at least one encryption key from a set of one or more encryption keys depending on its operational mode.

The operational mode may be selected by way of a hardware-based switch on the data reading device. Alternatively, the device may be commanded into one of the plurality of operational modes by a connected mobile device. The data reading device may be connected to the mobile device by a physical communications interface, or a wireless communications interface.

Preferred and/or optional features of the aspects of the disclosure may be combined with other ones of the aspects of the disclosure.

### DRAWINGS

In order that the disclosure may be more readily understood, reference will now be made, by way of example, to the accompanying drawings in which:

FIGS. 1a and 1b show a method of digitizing a payment card;

FIGS. 2a, 2b and 2c show an alternative method of digitizing a payment card;

FIG. 3 is a schematic representation of a personal mobile computing device and a card reader that are involved in the methods of FIGS. 1a, 1b and FIGS. 2a-2c;

FIG. 4 illustrates a data capture and management process involved in the above payment card digitization methods;

FIG. 5 is a block diagram illustrating a financial transaction;

FIG. 6 illustrates a process carried out within the environment of the financial transaction of FIG. 5; and

FIG. 7 illustrates another process carried out within the environment of the financial transaction of FIG. 5.

### DETAILED DESCRIPTION

The digitization of physical payment cards into non-physical ‘electronic’ or ‘digital’ cards allows payments to be made through mobile devices. Typically, a mobile device will carry a digitized version of a physical payment card in a digital wallet. Mobile devices may be equipped with Near Field Communication (NFC) technology to allow contactless communication with point of sale equipment at a merchant in order to initiate a payment transaction. Although a card issuing entity (hereinafter ‘issuer’) has the necessary systems infrastructure to accept transactions relating to the physical card that it has issued, it may not have the necessary systems infrastructure to accept transactions relating to digital versions of physical cards it has issued. If so, it may be unable to allow the physical cards it issues to users to be digitized which restricts services that are provided to its users and also hampers take-up of ‘digital’ payment processes in general.

For the avoidance of doubt, it should be noted here that use of the term ‘digital’ in relation to payment cards and the like should be taken to mean an electronic or ‘digitized’ version of a physical payment card that is associated with a user account, as has been created through a digitization process to enable mobile payments via appropriately enabled electronic devices such as smart phones and tablets.

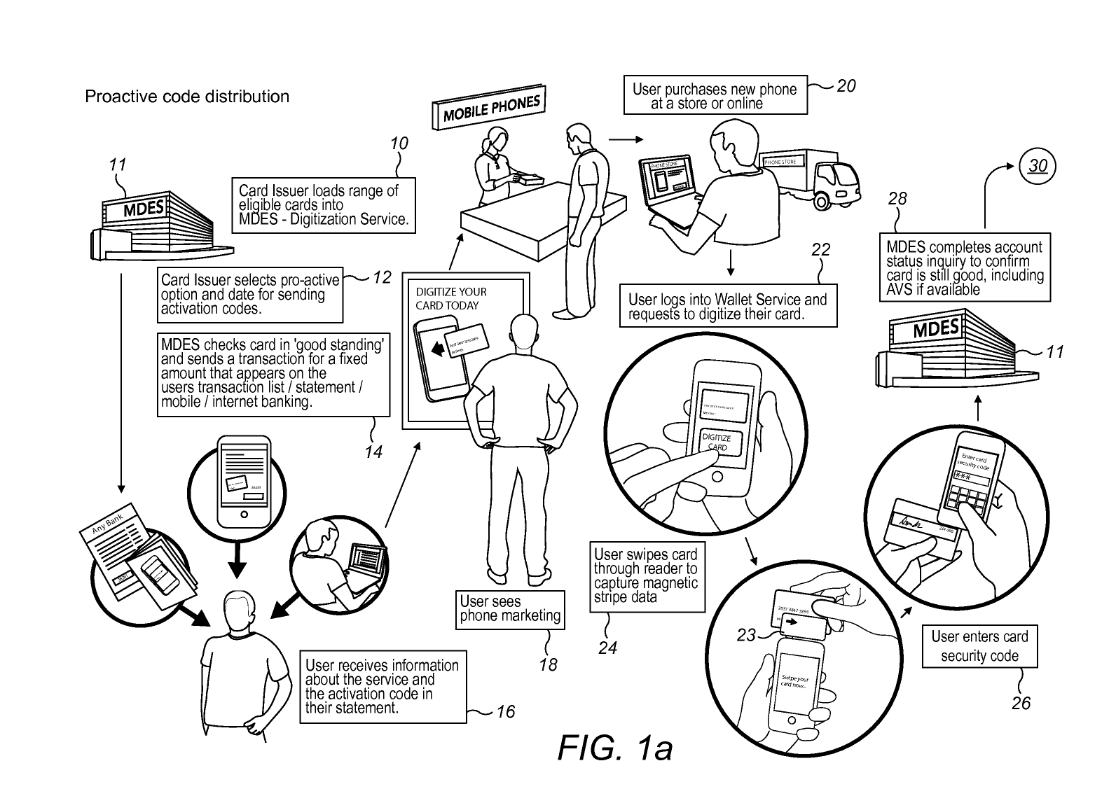

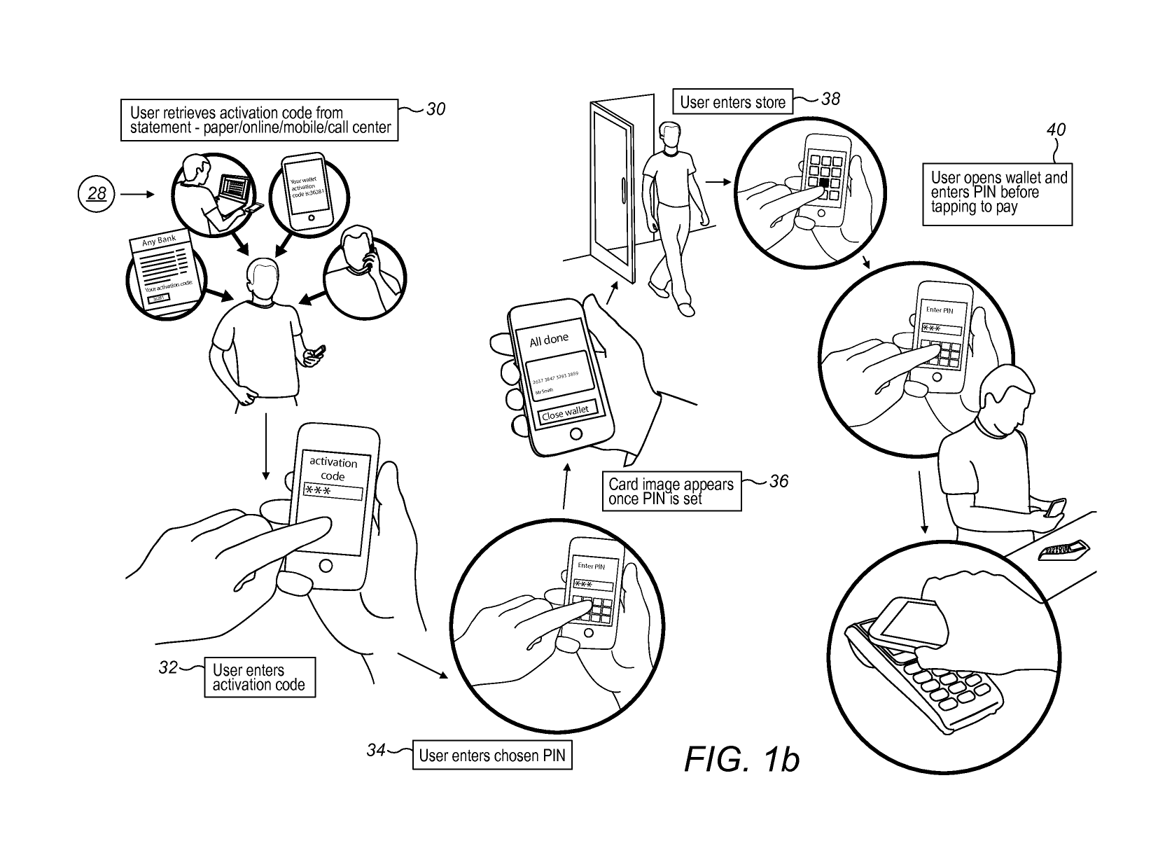

To put the disclosure into context FIGS. 1a-b, 2a-c and 3 show alternative processes through which a physical payment card, or more broadly described as a ‘physical transaction device’, may be digitized including different usage scenarios for activating a digital version of a physical payment card. In FIGS. 1a-b and 2a-c it is noted that an Activation Code for the service is generated and sent to the user who then subsequently enters the code as part of the registration process. The Activation Code may be distributed to the user in either a proactive manner or a reactive manner and these are described in more detail below. It is to be noted that the “Activation Code—generation and distribution” section described as part of the “Proactive code distribution” process may also be used within the “Reactive code distribution” process.

### Proactive Activation Code Distribution

Here, cards that are eligible for digitization are identified and Activation Codes are distributed to cardholders in advance of their subsequent use during the activation of the digital card issued to a mobile device.

Where card issuers do not opt-in to offer the digitization service to their cardholders, eligible cards may be identified by identifying qualifying card transaction activity within the payment network. Where card issuers do opt-in to offer the digitization service to their cardholders, eligible cards may be identified by the card issuer. Alternatively, the digitization service may identify eligible cards by creating card numbers within an opted-in card number range and verifying, using an Account Status Inquiry authorization message processed through the payment network to the card issuer, that the card number is valid and that an account exists and is therefore eligible.

For every eligible card, regardless of the method used to determine eligibility, an associated Activation Code shall be selected. The process of generating and distributing this Activation Code is described below. It is noted that this Activation Code—generation and distribution process may also be employed in a reactive code distribution system as described later.

### Activation Code—Generation and Distribution

The Activation Code may be randomly selected. Alternatively, the Activation Code may be derived algorithmically from the card number and the card security code printed on the back of the physical card, thus allowing for the digitization of the card to be linked to possession of the physical card.

The card issuer may determine whether each Activation Code may be used only once or multiple times and may limit the period of validity of each Activation Code. This permits a physical card to be digitized to multiple digital cards in multiple mobile devices.

The Activation Code for the eligible card is communicated to the cardholder by means of a nominal amount payment to the cardholder's card account, whereby the digitization service inserts the Activation Code within the “Merchant Name” data element within the payment transaction processed through the payment network.

Where the card issuer has opted-in to offering the digitization service, the card issuer may fund the payment. Alternatively, where the card issuer has not opted in to offering the digitization service, the digitization service or another third party may fund the payment.

The Activation Code required to activate a digital card associated with a physical card will appear on the cardholder's statement after the transaction has been cleared through the payment network. Typically this is within 2 days, but the period may be longer or shorter.

### Proactive Code Distribution Method—Continued

Returning now to the description of the proactive code distribution process, the card issuer may determine the date when the Activation Code is generated and communicated to the cardholder. This date may coincide with marketing campaigns or direct marketing of the digitization service. By determining the Activation Code for an eligible physical card in advance of the cardholder's request, the cardholder can gain immediate access to the Activation Code, whenever it is needed, from their statement. This may be before or after they initiate the digitization of their physical card, but typically would be immediately after requesting digitization. Existing, issuer-defined cardholder Identification and Verification methods would be used to gain access to the statement through whatever channel usually used by the cardholder. Such channels may be within a mobile banking application (‘app’), a web-based banking service or even using a monthly paper statement. The card issuer may add additional marketing materials explaining the digitization service with the mailed paper statement to encourage the use of the digitization service.

As explained in more detail below with reference to FIGS. 1a-b, when the digital card has been provisioned into the mobile device, it may be activated by entering the Activation Code into the Wallet App associated with the digital card. The digital card cannot make payments until activated. The cardholder enters and confirms his own choice of PIN that authorizes use of the digital card in contactless payment transactions. The digital card application validates that the Activation Code entered by the cardholder matches that provisioned by the digitization service, sets the PIN and activates the digital card.

### Reactive Activation Code Distribution

In this process, an Activation Code is distributed to a cardholder for use in the activation of the digital card issued to a mobile device following a cardholder request.

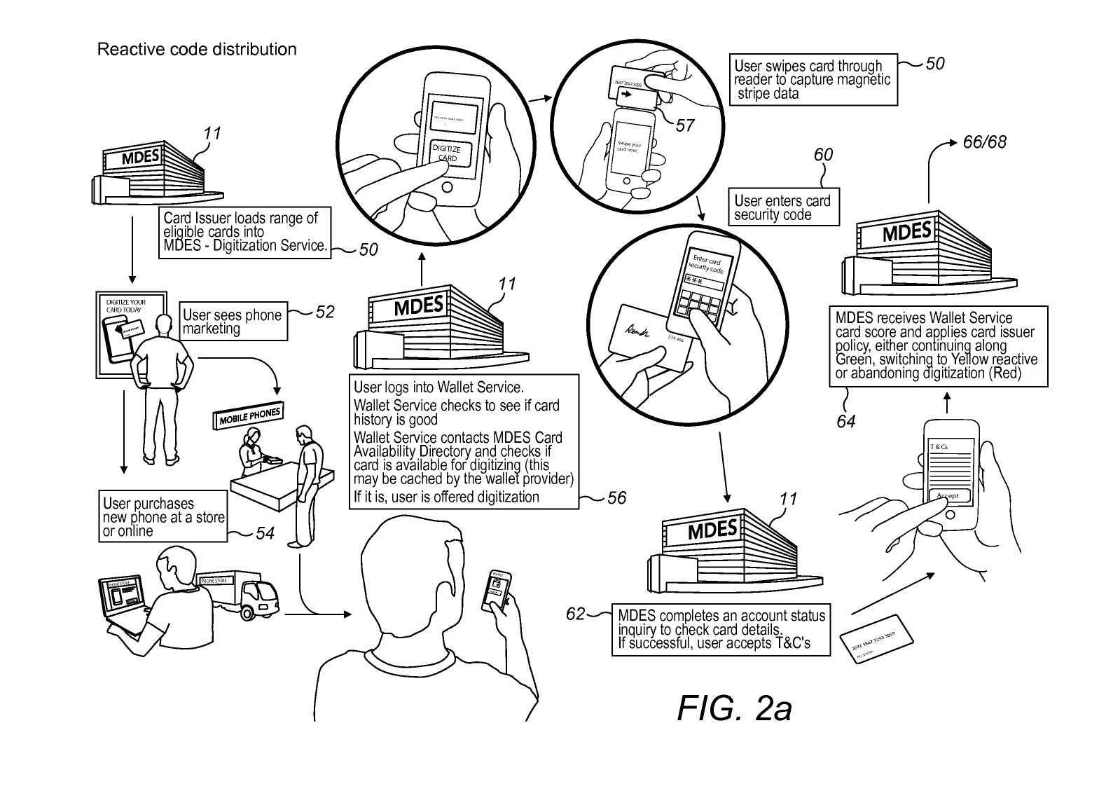

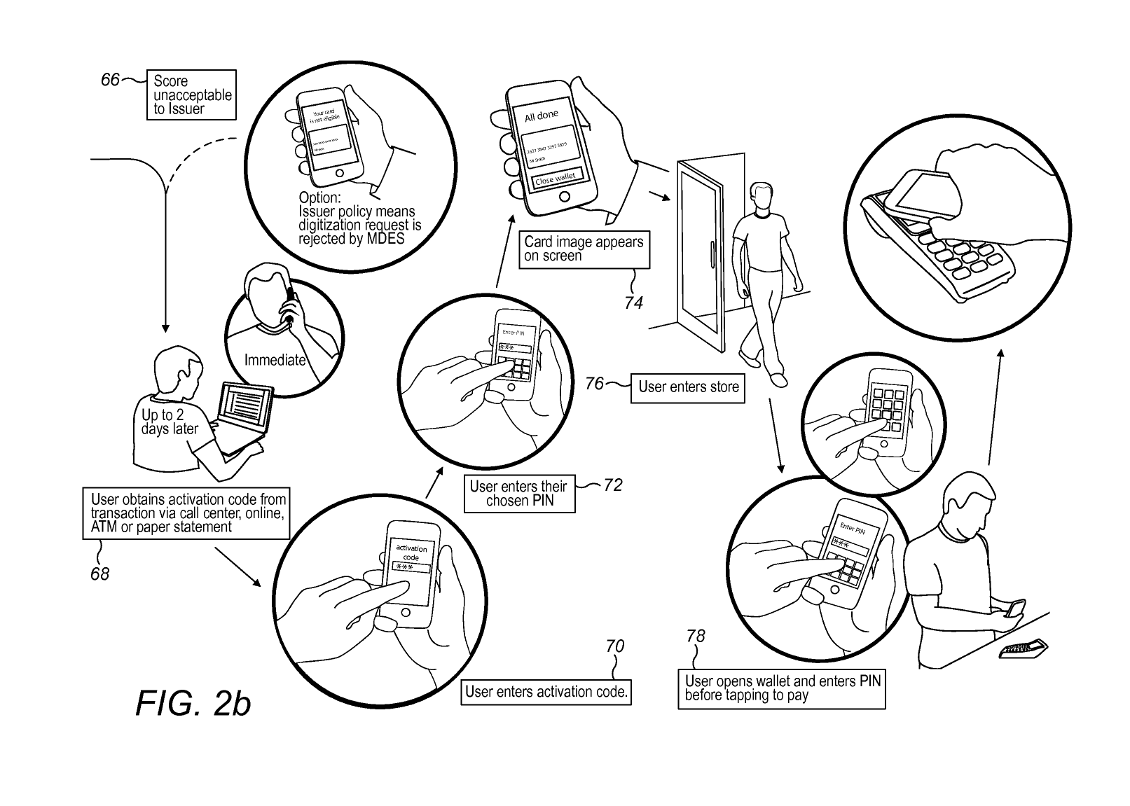

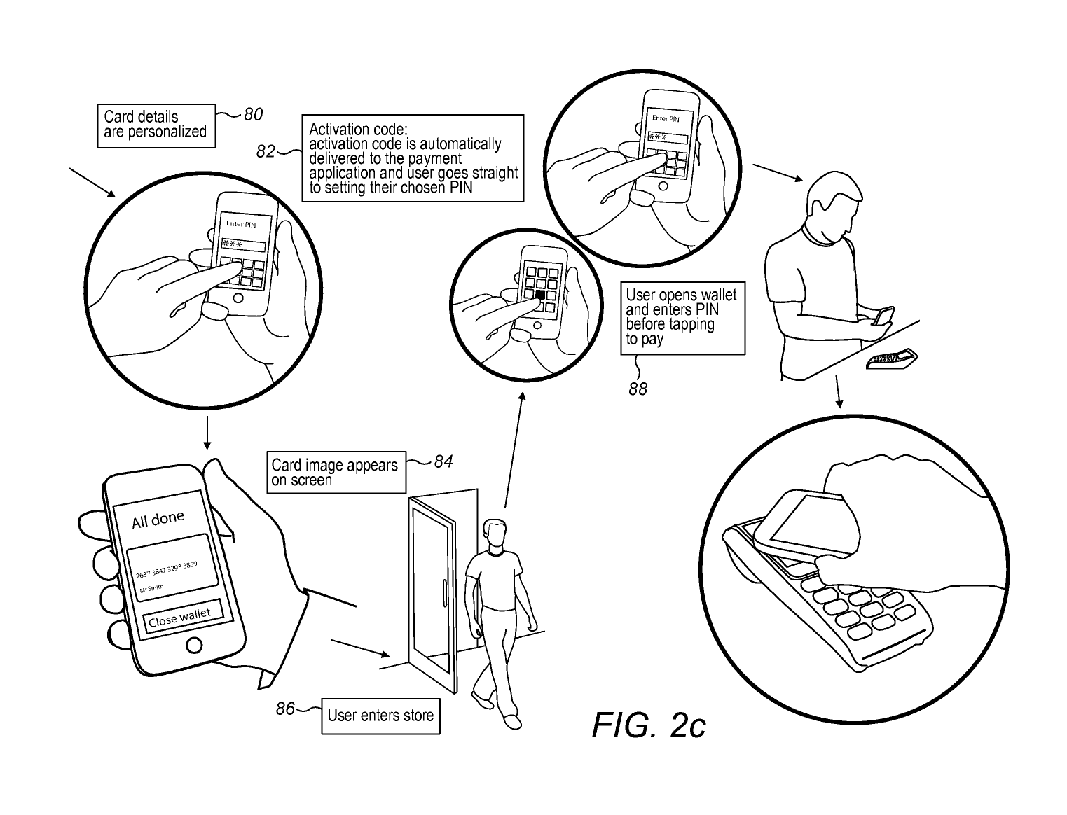

As shown in FIGS. 2a-c, a Cardholder requests the digitization of their card by supplying the card number of their physical card, the card security code printed on his physical card and optionally their address to the digitization service. Alternatively, a third party service provider may pass the cardholder's stored “card on file” information instead, with the cardholder providing only the card security code.

The digitization service checks that the card is eligible for digitization and verifies, using an Account Status Inquiry authorization message processed through the payment network to the card issuer, that the card number is valid, an account exists, the card security code is correct and when supplied the address is correct, and is therefore eligible. For every eligible card, an associated Activation Code shall be selected and distributed to the cardholder (user) in accordance with the Activation Code—Generation and Distribution process described above.

Returning now to the description of the reactive Activation Code distribution scenario, existing, issuer-defined cardholder Identification and Verification methods would be used to gain access to the statement through whatever channel usually used by the cardholder. Such channels may be within a mobile banking app, a web-based banking service or even using a monthly paper statement. The Activation Code will appear within a card issuer's authorization system immediately, allowing the cardholder to call their card issuer to retrieve the Activation Code when they digitize their card. As explained in more detail below with reference to FIGS. 2a-c, when the digital card has been provisioned into the mobile device, it may be activated by entering the Activation Code into the Wallet App associated with the digital card. The digital card cannot make payments until activated. The cardholder enters and confirms his own choice of PIN that authorizes use of the digital card in contactless payment transactions. The digital card application validates that the Activation Code entered by the cardholder matches that provisioned by the digitization service, sets the PIN and activates the digital card.

### First Digitization Scenario (Proactive Code Distribution)—FIGS. 1a and 1b

FIGS. 1a and 1b show a process wherein the Activation Code is sent to the user proactively, i.e. before the user decides that they wish to digitize their payment card.

In step 10, the issuer creates a list of payment cards that meet eligibility criteria for digitization and sends the list to the digitization service provider (MDES), as is indicated as reference numeral 11 in FIG. 1a. In step 12, the card issuing entity (issuer) decides to proactively send Activation Codes to each of the users associated with eligible payment cards. The process wherein the issuer decides not to proactively send Activation Codes is discussed with reference to FIGS. 2a-c below.

The following steps are then carried out for each of the eligible payment cards but the discussion below refers to a single card and associated user for conciseness.

In step 14, the digitization service provider checks that the payment card is in good standing, for example by checking that historical bills have been paid in a timely manner. Then the digitization service provider 11 sends a payment transaction for a fixed amount to the user. Here, the digitization service provider inserts an Activation Code into the merchant name field of the payment transaction which causes the Activation Code to appear on the user's summary of transactions, for example on a monthly paper statement, an electronic statement viewed online or at an automated teller machine. A payment transaction with a new Activation Code may be sent to the user once a month, or the same code may be sent monthly.

In step 16, the cardholder receives their summary of transactions and marketing material about the digitization service. The marketing material raises awareness of the digitization service and may comprise, for example, promotional pamphlets/booklets sent directly to the user or an advertising campaign online, on TV or on billboards. The marketing material emphasises a new payment device that is compatible with the digitization service, for example a mobile phone with NFC capabilities. The user sees the marketing material in step 18.

In step 20, the user purchases the new mobile computing device, either online or at a shop. Alternatively, the user may already own a mobile computing device that is compatible with the digitization service and would go straight from step 18 to step 22.

The user then initiates the set-up process of digitizing their payment card into their new mobile device. This process only needs to be carried out once for each payment card being digitized. The user creates a digital wallet on the new mobile device, or transfers an existing digital wallet to the new mobile device. In step 22, the user logs into their digital wallet on the new mobile device and requests to digitize their payment card.

At step 24 the cardholder uses a magnetic stripe card reader 23 that is coupled to the mobile device. The magnetic card reader 23 may be coupled to the mobile device by way of a mechanical connection, for example through the headphone socket of the mobile device or through a suitable mini- or micro-USB connector, or a proprietary connector. Alternatively, it may be connected wirelessly for example via a Bluetooth™ connection. The magnetic card reader may be supplied by the digitization service provider or, alternatively, it may be purchased by the user from a third party. The card reader device will be described in more detail later, but a brief overview will now be provided.

At this point the magnetic stripe card reader reads the data set contained on the physical card (the physical data set), encrypts the data and loads it onto the mobile device. Optionally, the card reader 23 may have two modes of operation, which may be activated by a suitable switch. In a first mode of operation, the card reader is able to encrypt the card data with cryptographic keys as provided by the digitization service provider primarily for the purpose of card digitization. In a second mode of operation, the card reader is able to encrypt the card data with cryptographic keys as provided by an ‘acceptance service provider’ primarily for the purpose of payment acceptance.

The user is then prompted, at step 26, to enter their card security code which is the three digit code towards the right hand side of the signature strip on the back face of the card. The card security code is also sometimes known as the Card Verification Value by some service providers, and as the Card Verification Code by some other providers and is a security feature inherent in payment transactions associated with magnetic stripe-based cards to guard against so-called ‘cardholder not present’ fraudulent activity.

Typically, the data included in the magnetic stripe will include: a primary account number of the physical card (Funding primary account number or FPAN′); the account holder name; the expiration date of the card, the service code, and a discretionary data which may include the card security code, as discussed above, and a pin verification value.

In step 28, the physical data set from the physical payment card is uploaded to the digitization service provider 11, together with suitable cryptographic data as obtained from the card reader 23, and it is confirmed that the payment card is still in good standing, including using an address verification system (AVS) to verify the address of the user claiming to own the payment card, as it may have been several weeks or months since the initial check carried out in step 14. If the payment card is still in good standing, the digitization process is allowed to continue. At this point, the digitization service provider stores the physical device data set (including suitable cryptographic data, as appropriate) in order to be able to associate the physical data set with the newly created digital device data set, including a digital primary account number (DPAN) as part of the digitization process during a subsequent transaction with the digital version of the card, as will be described later.

The user is then prompted to enter the Activation Code by the digital wallet. In step 30 (see FIG. 1b), the user retrieves the Activation Code from their summary of transactions. The user then enters the Activation Code into the digital wallet in step 32.

Steps 24 and 30 enhance the security of the digitization process by requiring the user to possess both the payment card and have access to the summary of transactions. These steps prevent fraudulent activation of the digitization service by a third party on their own payment device.

In step 34, the user creates a secure personal identification number (PIN) and may be prompted to re-enter it for confirmation. The digital wallet indicates to the user in step 36 that the payment card has been successfully digitized and displays a card image to the user. By being successfully digitized, the digital wallet now includes a card record that includes a digital version of the physical payment card including data such as a Digital Primary Account Number (DPAN), suitable cryptographic information and suitable static data.

Now, the digital card is ready for use, and so the user is able to use the mobile device to purchase goods and services. For example, the user is illustrated at step 38 entering a store such as a supermarket where, at the supermarket checkout, the user opts to pay with the new mobile device in step 40. Therefore the user opens the digital wallet and enters the PIN on the mobile device. Then the user initiates the payment transaction by bringing the mobile device in sufficient proximity to a Point of Interaction (POI) for the NFC to be functional. The POI and the mobile device communicate through the NFC connection and successfully complete the payment transaction.

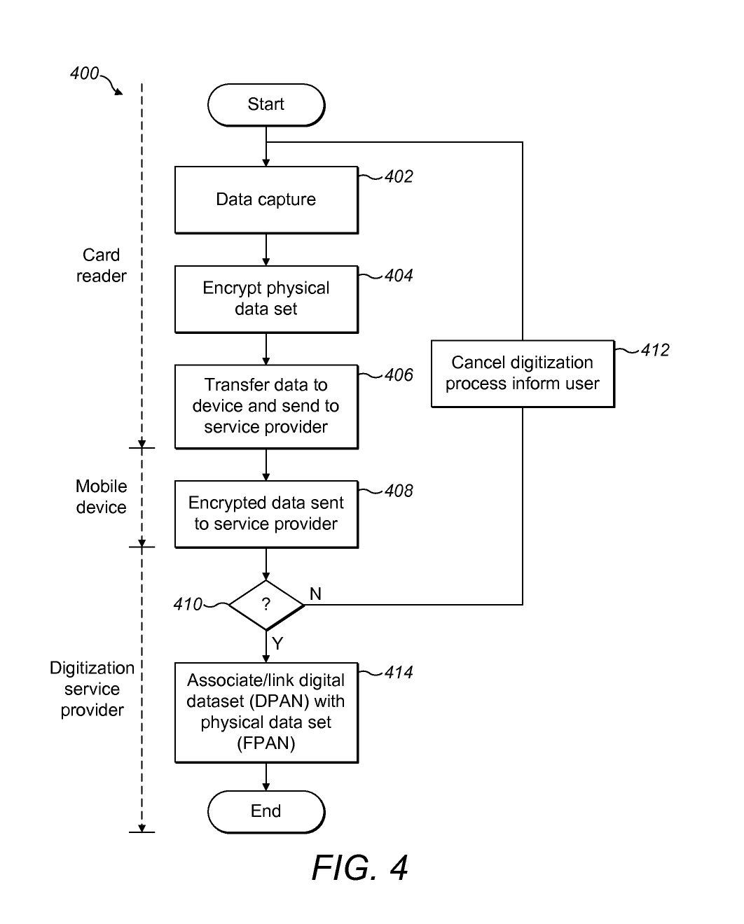

The process then enters a payment transaction process according to an embodiment of the disclosure and as will be described later with reference to FIG. 4.

Second Digitization Scenario (Reactive Code Distribution)—FIGS. 2a, 2b and 2c

FIGS. 2a-c show a card digitization process in which the Activation Code is sent to the user reactively, i.e. after the user decides that they wish to digitize their payment card.

In step 50, the issuer creates a list of payment cards, that meet eligibility criteria for digitization and sends the list to the digitization service provider 11. In this case, the issuer has chosen to send Activation Codes to users after the users request to digitize their payment cards. The following steps are then carried out for each of the eligible payment cards but the discussion below refers to a single card and associated user for conciseness.

In step 52, the cardholder sees marketing material about the digitization service. The marketing material raises awareness of the digitization service and may comprise, for example, promotional pamphlets/booklets sent directly to the user or an advertising campaign online, on TV or on billboards. The marketing material emphasises a new payment device that is compatible with the digitization service, for example a mobile phone with NFC capabilities. Hereinafter, therefore, the payment device will be referred to as a mobile device.

In step 54, the user purchases the new mobile device, either online or at a shop. It should be appreciated that the user may already own a suitable mobile device that is compatible with the digitization service, in which case the process proceeds straight from step 52 to step 56.

The user then initiates the set-up process of digitizing their payment card into their new mobile device. This process only needs to be carried out once for each payment card being digitized. The user creates a digital wallet on the new mobile device, or transfers an existing digital wallet to the new mobile device. In step 56, the user logs into their digital wallet on the new mobile device and requests to digitize their payment card. At this step, the wallet service provider communicates with the digitization service provider and verifies that the card that is requested for digitization is available via a suitable directory. As an alternative to directly checking with the digitization service provider, the directory of cards available for digitization may be held locally at the wallet service provider. If the card is available for digitization, then the user is offered digitization and is prompted to being the process by a suitable display on the mobile device.

At step 58 the cardholder uses a magnetic stripe card reader 57 that is coupled to the mobile device. As described in the process of FIGS. 1a, 1b, the magnetic card reader 57 may be coupled to the mobile device by way of a mechanical or wireless interface and may be supplied by the digitization service provider or, alternatively it may be purchased by the user from a third party.

At this point the magnetic stripe card reader 57 reads the data set contained on the physical card (the physical data set), encrypts the data and loads it onto the mobile device. Encrypting the physical data before it is passed to the mobile device provides a security measure and prevents unauthorized access to the data.

The user is then prompted, at step 60, to enter their card security code which is the three digit code towards the right hand side of the signature strip on the back face of the card, as discussed above in relation to FIGS. 1a-b. At this point, therefore, the mobile device holds a data set including all physical card data necessary to perform a transaction and the mobile device transmits the physical data set to the digitization service provider.

The digitization service provider then confirms the good standing and verifies the address of the user. If the payment card is in good standing and the address is verified, the digitization process is allowed to continue and the digitization service provider triggers the mobile device to display a set of terms and conditions (T&Cs) to the user.

Following acceptance of the T&Cs by the user, at step 64 the digitization service provider queries the wallet service provider (which may be the digitization service provider itself, or alternatively a third party such as the card issuer or a product/service vendor) to check the credit worthiness of the card that the user wishes to digitize. In response, the digitization service provider receives a card score value which dictates the usage policy that will be imposed on the card by the card issuer. For example, the card score may be low such that the issuer does not permit the card to be digitized (see step 66), or may be such that the card issuer does permit the payment card to be digitized provided that further activation steps are complied with (steps 68-74)—this may occur where a wallet service provider recommends that a card may be digitized, but that the issuer of that card is unwilling to rely on the positive score assessed by the wallet service provider.

Alternatively, the card score may be such that the issuer agrees immediately to the digitization of the payment card without further verification, as will be described later with reference to FIG. 2c.

In FIG. 2b, step 66 illustrates the result of a negative outcome of the card scoring process. Here, the card score is unacceptable to the issuer so the digitization service terminates the digitization of the card immediately, issuing a suitable message to the mobile device of the user.

In an alternative scenario, described from steps 68 onwards, the card score is acceptable but further verification is required in order to fully complete the digitization process. Here, at step 68 the digitization service provider 11 sends a payment transaction for a fixed amount to the user and inserts an Activation Code into the merchant name field of the payment transaction. This causes the Activation Code to appear on the user's summary of transactions. The user then obtains the Activation Code from the transaction, but this may take up to two days to clear through the payment network and appear on the user's summary of transactions. Alternatively, as the Activation Code appears to the issuer almost immediately and so the user can telephone the issuer to obtain the Activation Code and proceed with the digitization process immediately.

In the next stage of the process, the digital wallet prompts the user to enter the Activation Code and the user enters it in step 70. Following this, the user creates a secure personal identification number (PIN) at step 72. At step 74, the digital wallet indicates to the user that the payment card has been successfully digitized.

The user is then able to use the new payment device to purchase goods and services. For example, the user is shown entering a store such as a supermarket in step 76. At the supermarket checkout, the user takes the option of paying for their goods with the mobile device and, therefore, opens the digital wallet and enters the PIN on the mobile device at step 78. Then the user initiates the payment transaction by bringing the mobile device in sufficient proximity to the POI for the NFC to be functional. The POI and the mobile device communicate through the NFC connection and successfully complete the payment transaction.

Returning to the card scoring procedure at step 64, it has been mentioned above that one alternative is that the issuer permits the digitization of the payment card without further interaction with the user through Activation Codes. So, with reference to FIG. 2c, at step 80, which follows on directly from step 64, the details of the card are personalised to the user and the Activation Code is transmitted directly to the payment application on the mobile device at step 82. Here, ‘personalisation’ means that the digital device in the digital wallet on the mobile device is in effect ‘populated’ with suitable data such as the DPAN, cryptographic data, card expiry information, and other settings that configure the digital device according to the wishes of the issuer. The user is therefore not required to interact with their payment transaction history in order to obtain an Activation Code, which is enabled by their high card score from the wallet provider, as discussed above. The user is taken directly to a pin-setting page of the payment application and, once accepted, the card digitization process completes at step 84 by showing a suitable message on the user's mobile device.

Once again, at this point the user is able to user the mobile device to purchase goods and services and, by way of example, is shown entering a store such as a supermarket at step 86.

At the supermarket checkout, the user takes the option of paying for their goods with the mobile device and, therefore, opens the digital wallet and enters the PIN on the new payment device at step 88. Then the user initiates the payment transaction by bringing the new payment device in sufficient proximity to the POI for the NFC to be functional. The POI and the new payment device communicate through the NFC connection and successfully complete the payment transaction.

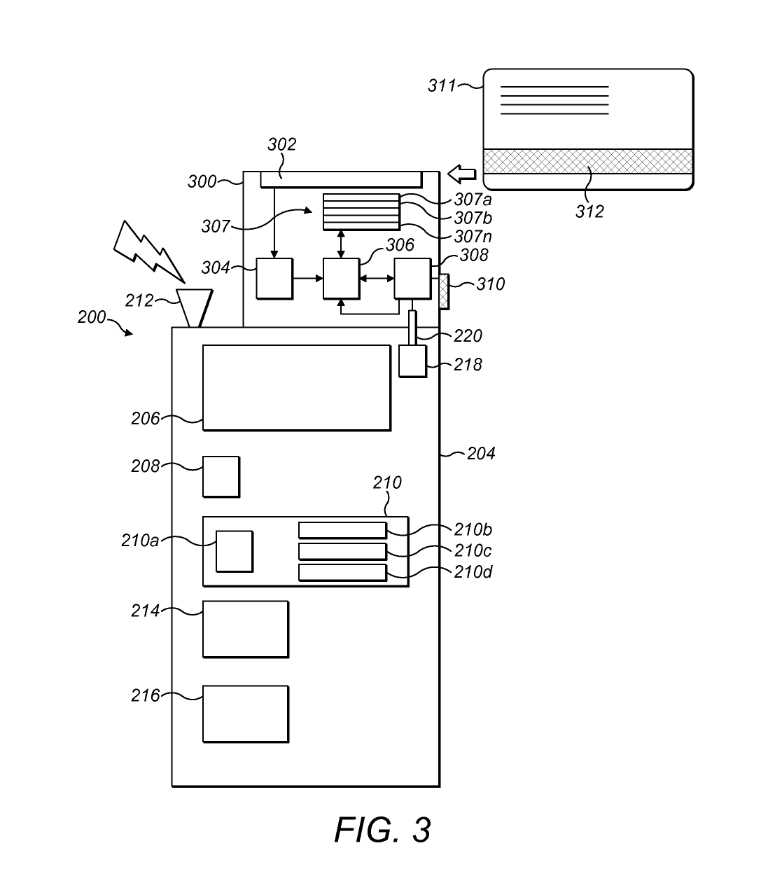

### Apparatus and Processes for Data Capture and Management—FIGS. 3 and 4

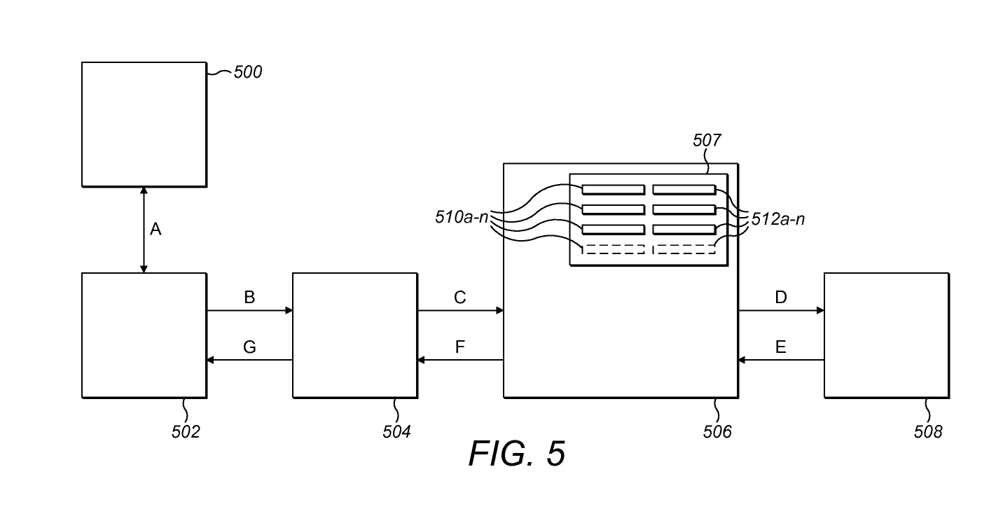

The above discussion with reference to FIGS. 1a-b, and FIGS. 2a-c describe alternative scenarios in which a physical card having a physical device data set may be digitized into a digital version of the card having a digital device data set which identifies the same user account. It should be noted that during the digitization process, the physical card is read or ‘captured’, and preferably, encrypted, by a suitable magnetic stripe card reader (indicated by references 23 and 57) in order to identify a physical data set of the card, and that this data set is communicated to, and stored by, the digitization service provider 11 in order to be used in a subsequent financial transaction between a cardholder and a merchant. Such a financial transaction will be described later with reference to FIGS. 5, 6 and 7. However, the process by which data from the physical card is captured and transferred to the digitization service provider and suitable hardware involved in the process will now be explained in more detail with reference to FIGS. 3 and 4.

A suitable mobile device 200, card reader apparatus 300 and payment device 311 in the form of a payment card are shown schematically in FIG. 3. The mobile device 200 may be any suitable computing device but preferably a mobile phone or a tablet computer by way of non-limiting example. Although it is envisaged that mobility of the device is necessary to enable the device to be used by a user in different stores or merchants, this is not essential, since the computing device could also be used in a static environment, such as in a small business where it could be used to take payments from customers as parts of its suite of applications.

In overview, the mobile device 200 comprises a body 204 housing a display means 206 in the form of a screen, a user interface module 208, a processing module 210, an antenna 212, a communications interface module (CIM) 214, a wireless transceiver module 216, and a data interface 218.

The display screen 206 and the user interface module 208 are linked so that the user can input data into the device 200 via the display screen 206, as is known. Alternatively, or in addition, a key-based data entry system may be provided.

The antenna 212 is controlled by the CIM 214 and so provides a means for the device 200 to communicate with radio telecommunications networks in a known manner.

The processing module 210 provides the processing functionality for the device 200 and, as shown here, includes a central processing unit 210a and a plurality of memory modules 210b-d. The memory modules comprise a first memory module 210b being preferably non-volatile for storing suitable BIOS and boot programs and the like, a second memory module 210c, preferably being volatile memory, for storing (semi-) permanent and temporary software applications or ‘apps’ for execution by the processing module 210a, and a third memory module 210d, also being preferably non-volatile, for storing data generated by the software applications executed on the device 200.

The wireless transceiver module 216 provides the device 200 with the facility to communicate wirelessly with other devices or networks under a variety of communications protocols, for examples as governed under the IEEE 802.11 standards as would be known to the skilled person.

The card reader apparatus 300 is electrically coupled to the mobile device 200 so that data can be transferred between them. Conveniently, in this embodiment, the card reader apparatus 300 (hereinafter ‘card reader’) is electronically coupled, but also mechanically coupled, to a headphone interface or ‘socket’ 220 of the mobile device 200, the socket 220 acting to mechanically attach the card reader 300 to the mobile device 200 but also to enable the transfer of data, control commands and information.

As has been described above, the card reader 300 provides the facility to read data from the payment card 311 of a user, transfer this to the mobile device 200, wherein the data is then uploaded from the mobile device 200 to the digitization service provider.

In overview, the card reader 300 comprises a magnetic reading head 302, a coder/decoder or CODEC 304, an encryption module 306, a secure data store 307, a control module 308 and a user interface 310. The card reader 300 may also be provided with a power source such as a battery or capacitor (not shown) if it is unable to draw sufficient operating power from the interface with which it is engaged with the mobile device 200.

The magnetic reading head 302 is operable to read data from the data storage unit of the payment card 311, denoted here by reference number 312. As discussed, the card reader may read track 1 or track 2 data, in order to capture the primary account number (FPAN) of the payment card. The data from the payment card or ‘physical device data set’ is then transferred to the CODEC 304 which decodes the magstripe data and sends it to the encryption module 306. Customarily, the magnetic reading head 302 may include a receiving part such as a slot through which the card is guided in order for the magstripe to be read. However, the receiving part need not be a slot and other configurations are possible. For instance, in a chip and pin enabled payment device/card, the receiving part may be a slot, but it may also be a touch interface on the exterior surface of the card reader 300. Thus, the receiving part may house either a magnetic reading head in the case of the device being configured to read a magstripe card, or a chip reading head in the case of a device being configured to read a ‘chip and pin’ card.

The encryption module 306 encrypts the incoming magstripe data including the physical device data set and passes this to the control module 308 which handles the output of the data. In encrypting the physical device data set, the encryption module 306 queries the secure data storage unit 307. The secure data storage unit 307 stores a plurality of encryption keys 307a-n that may be used to encrypt the physical data set, as discussed above and below. The encryption module 306 may select a specific encryption key as directed by the control module 308 to determine which key to use based on various criteria. It is envisaged that one way in which this might be achieved is by a user selecting an operational mode of the card reader 300 via the user interface 310, which may be a simple hardware switch. The user may therefore control the card reader into one of a number of modes e.g. a first mode so a specific encryption key is selected for payment processing, and a second mode in which a different encryption key is selected for card digitization.

Following encryption of the physical data set, the encrypted data is then transferred to the mobile device 200 after which it is processed by a suitable software application which sends the encrypted data to the digitization service provider.

Note that the digitization service provider is shown in FIG. 5 at reference numeral 506, the functionality of which is provided by a transaction processing organisation, for example Visa® or MasterCard® as will be described. Although the functionality of the digitization service provider 506 has already been discussed above, it will now be explained in more detail with reference to the flowchart of FIG. 4.

The data capture and transfer process 400 may be initiated in various ways, for example, it is envisaged that the process could start by a user swiping the payment card, or through a suitable banking app on the mobile device 200. In either case, at step 402, the card data is read from the payment card, for example, by the user swiping the magstripe through the magnetic reading head 302 of the card reader 300. At this point, therefore, the card reader 300 has captured the ‘physical device data set’ from the payment card, principally containing the primary account number or (FPAN). At step 404, the card reader 300 encrypts the physical data set at the encryption module 306 using a suitable encryption key 307a-n as discussed above, and then transfers the encrypted physical device data set to the mobile device 200 at set 406, wherein it is then sent by way of a suitable telecommunications network to the digitization service provider at step 408.

Once the digitization service provider receives the encrypted physical device data set and suitable cryptographic data, it performs a set of verification checks at step 410 to ensure that the payment card is still in good standing. If the digitization service provider determines that the payment card is no longer in good standing the digitization process is discontinued at step 412 and the user is informed, as is described at step 66 in FIG. 2c.

If however the payment card passes the verification checks, the digitization service provider decrypts the physical device data set and stores the FPAN in a secure data area at step 414. At this point, the digitization service provide pairs, links, associates, or otherwise corresponds the FPAN to the digitized data set that is has already determined for the account and which is also stored in the secure database. Note that the secure database is indicated by reference numeral 507 as part of the digitization service provider 506 in FIG. 5, that the physical device data sets are identified as 510a-n and that the digital device data sets are identified as 512a-n.

Once the data capture and transfer process of FIG. 4 has been carried out, the digitization service provider is able to perform its functionality as a transaction processing system during a payment transaction, as will now be described.

### Payment Transaction—FIGS. 5, 6 and 7

FIG. 5 illustrates a block diagram of a financial transaction between a mobile device 500 of a user/cardholder and a merchant 502. The process also includes the following entities or actors: a merchant acquirer bank, or more simply ‘acquirer’ 504, an issuing bank, or more simply ‘issuer’ 508, and an organisation 506 that facilities the routing/processing of financial transactions between acquirers 504 and issuers 508. In the United Kingdom context, the service provided by the organisation may be provided by a payment network infrastructure brand such as Visa® or MasterCard®, although the skilled person will be aware of other such service organisations. Hereinafter, the organisation will be referred to as the ‘transaction processing system’ and will be the same organisation that provides the digitization service as described above, that is to say, the digitization service provider 506. Here the services provided by the digitization service provider 506 and the transaction processing system are provided by the same organisation, but it should be appreciated that this need not be the case.

At this point, it should be appreciated that the terms ‘issuer’, ‘acquirer’, ‘merchant’, ‘transaction processing system’ and the like are intended to mean computer implemented systems that represent those establishments and that are able to communicate data and instructions between one other, as appropriate, using established protocols.

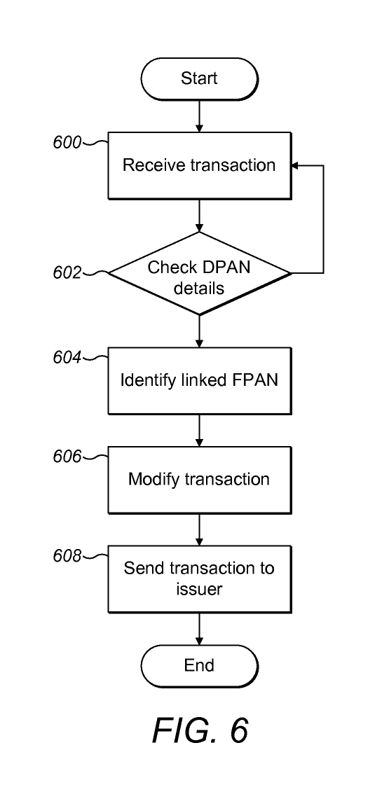

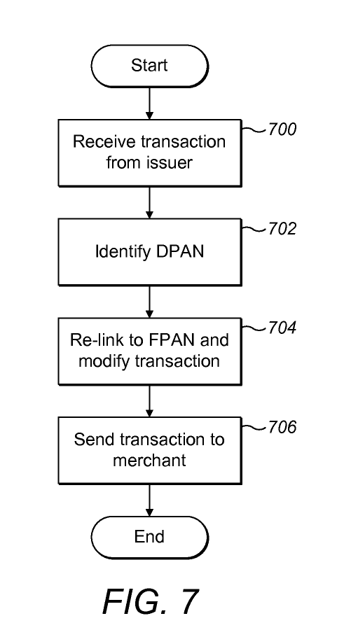

It should be noted that whereas FIG. 5 describes the financial transaction in overview, FIGS. 6 and 7 illustrate diagrammatically steps performed by the transaction processing system during certain parts of the transaction, and so reference will be made to FIGS. 6 and 7 as appropriate.

The financial transaction is envisaged to be a payment transaction for the purchase of goods/services in which the merchant 502 communicates with a financial transaction network for authorisation for the payment prior to later completion of the transaction by way of a clearance and settlement process, as would be known to the skilled person. Alternatively, the transaction may be a chargeback transaction. A chargeback transaction is one which usually occurs due to the user being unhappy with the goods or services acquired through a payment transaction and seeks to retain a refund. In addition to transactions that originate at physical terminals at a merchant's ‘bricks-and-mortar’ establishments, a transaction could be generated in an online environment or in an ‘in-aisle’ purchasing environment.

The process begins by the initiation of a financial transaction by the mobile device 500, for example the mobile device as described above, communicating with the merchant 502 as indicated by arrow ‘A’ in order to pay for goods and services. As discussed above, the communication between the mobile device 500 and the merchant 502 may be via NFC technology.

At this point the mobile device 500 accesses a digital wallet held on it as a suitable app and accesses the digital device data set, including a Digital Primary/Payment Account Number—DPAN), of the physical payment card that has been captured and stored by the digitization service provider in the processes described above.

The merchant 502 then constructs a payment transaction message and communicates with the acquirer 504 via a dial-up line, for example, in order to obtain an authorization for the payment that the user wishes to make with their mobile device, as indicated by arrow ‘B’. Typically, a digital payment transaction message may comprise at least: the DPAN, the merchant terminal ID, and the transaction amount. In response, the acquirer 504 then communicates the transaction to the transaction processing system 506, as illustrated by arrow ‘C’.

At this point, reference will also be made to FIG. 6 which illustrates the process carried out by the transaction processing system 506 and which begins at the point it has received the transaction from the acquirer 504 at step 600 Before communicating with the issuer 508, the transaction processing system 506 carries out suitable cryptographic checking of the transaction, based on the cryptographic information that was generated as part of the digital card generation process and also performs suitable verification checks on the DPAN to ensure that the account is in good standing (FIG. 6—step 602).

At this point the transaction processing system 506 is required to communicate with the issuer 508 of the payment card in question. However, in the context of the disclosure, the issuer 508 does not support transactions relating to digital data sets including DPANs, since they only have the systems infrastructure to support transactions relating to physical device data sets, including FPANs (Funding Primary Account Number), of physical cards that the issuer has issued to users. So the transaction processor 506 is configured to carry out a mapping procedure (FIG. 6—step 604) to associate the digital device data set in the transaction received from the acquirer 504, and as originally constructed by the merchant 502, to the physical device data set associated with the physical payment card, and as uploaded to the transaction processing system 506 acting as the digitization service provider during the card digitization process. In this procedure, as has been described above, the transaction processing system 506 refers to the stored digital device data sets stored in the database 507, each digital device data set being linked, or otherwise associated, with a corresponding physical device data set. Note that in FIG. 5, the digital device data sets are indicated by reference 510a-n and the physical device data sets are indicated by reference 512a-n.

Once the transaction processing system 506 has mapped the digital device data set to the corresponding physical device data set, it modifies the transaction to include the physical device data set (FIG. 6—step 606) and communicates the modified transaction to a suitable issuer 508, as illustrated at arrow ‘D’ (FIG. 6—step 608). In modifying the transaction, the transaction processing system 506 may be configured to incorporate the FPAN into the transaction message by inserting the FPAN into a dedicated data field or, alternatively, the FPAN may overwrite the DPAN that is already contained in the transaction message.

The issuer 508 therefore processes the transaction as it would do for a conventional transaction of a physical card: the digital version of the physical card is therefore hidden from the issuer 508 and, as such, the issuer 508 is not required to update its systems infrastructure to support digital payments, for example from mobile devices. The issuer 508 then carries out necessary credit worthiness checks to ensure that the account balance of the cardholder is sufficient to cover the payment amount and fraudulent activity checks and communicates a response to the transaction processing system 506, as illustrated at arrow ‘E’, either granting authorization for the transaction or denying authorization.

Following a response form the issuer 508, the transaction processing system 506 carries out a reverse-mapping procedure, which is illustrated in FIG. 7, and which begins at step 700 at which the transaction processing system 506 receives the transaction message back from the issuer 508.

At steps 702 and 704 the transaction processor queries the database 507 to identify once again the relevant DPAN that corresponds to the FPAN that exists in the transaction message returned by the issuer 508 and modifies the transaction to the digital device data set, including the DPAN, as the transaction was originally constructed. At this point, the transaction will also include the authorization/denial from the issuer 508 and the transaction processing system 506 communicates back to the acquirer 504 as illustrated by arrow ‘F’ (FIG. 7—step 706).

Having received the transaction including the DPAN and the authorization/denial from the issuer 508, the acquirer 504 then communicates the transaction back to the merchant 502, as illustrated at arrow ‘G’. At this point, the merchant 502 has received the authorization for the original transaction for the digital device data set and so the merchant 502 communicates the authorization to the mobile device 500, as illustrated by arrow ‘A’, thereby completing the transaction.

As has been described above, the transaction processing system 506 sits between the merchant acquirer 504 and the issuer 508 and performs an interpretation service to translate the digital device data set within the transaction (as constructed by the merchant at the instigation of the mobile device carrying the mobile wallet having a digital version of the physical payment card) to a physical device data set that can be processed by the issuer 508 who would otherwise be unable to support the transaction. Beneficially, therefore, the systems and methods of the disclosure enables more card-issuing organisations to support digital payment transactions from mobile devices without requiring the card-issuing organisations to make significant upgrades to their system infrastructures, thereby encouraging take-up by those organisations.

The present disclosure also improves security of payment transactions. Payments by cards having physical device data sets held within magnetic stripes are prone to fraud since the data can be cloned and the card details used in fraudulent transactions. The digital versions of physical cards are inherently more secure since they make use of dynamic card authentication processes (known as Dynamic Data Authentication, DDA) instead of static processes (known as Static Data Authentication, SDA). The disclosure facilitates the propagation of digital versions of physical cards in countries where the EMV® (Europay, MasterCard® and Visa®) standard has not yet been rolled-out since card issuing entities are not forced to upgrade their systems prior to accepting digital payment transactions by mobile devices.

In each of the digitization scenarios described above with reference to FIG. 1 a,b, 2a-c, the user is required to process their physical card through a card reader device 23, 57, 300 which triggers the process of capturing a physical data set from ‘track 1’ or ‘track 2’ data contained on the card, either on the magnetic stripe or on the integrated chip within the card, and sending that physical data set to the digitization service provider. This enables the digitization service provider to perform its mapping service such that a digital data set received during a transaction relating to a digital version of a physical card may be converted to a physical data set relating to the physical counterpart of the digital card.

As also discussed above, it is envisaged that the card reader device 23, 57, 300 may be operable in more than one mode. For example, in a first mode of operation, which can be considered to be a ‘digitization mode’, the card reader device may include a first set of cryptographic keys or ‘items’ provided by the digitization service provider so that the card data can be digitized and transmitted to the digitization service provider securely without fear of interception or tampering.

In a second mode of operation, which can be considered to be an ‘acceptance mode’, the card reader device may include a second set of cryptographic keys or ‘items’ provided by a transaction processor (which may be the digitization service carrying out this function), so that financial transactions can be performed securely without fear of interception or tampering.

Having more than one mode of operation, in this case two modes of operation, gives the card reader device greater utility since it can be used in conjunction with a mobile device both to perform financial transactions with customers, and also to digitize physical payment cards, thereby providing a more flexible and cost effective device. In each of the different modes, it is envisaged that the mobile device would operate with a suitable app corresponding to that mode of operation. In theory, alternative cryptographic schemes or algorithms could be used in each of the different operational modes.

The mode of operation may be configured by a hardware-based switch provided on the card reader device. Depending on the switch position, therefore, the card reader may select an appropriate set of cryptographic keys to use. The mobile device may boot up the appropriate app to use with the operational mode of the card reader device when initiated by the user. Alternatively, it is envisaged that the card reader device may communicate with the mobile device to inform the mobile device of its operational mode and, in response, the mobile device may itself boot up the appropriate app without interaction with the user.

In a still further alternative, it is envisaged that the mobile device may drive the selection of the operational mode of the card reader device. For example, the mobile device may boot up an appropriate app as initiated by the user either for a financial transaction or for a card digitization service. Upon starting the app, the mobile device may communicate with the card reader device through the machine interface to configure its operational mode appropriately thereby selecting the most suitable cryptographic key to use. If the card reader device is attached to the mobile device at a headphone jack/socket, the mobile device may communicate the operational mode selection through that interface. However, the mobile device may also communicate the operational mode selection wirelessly with the card reader device, whether the card reader device is physically coupled to the mobile device or not.

It will be appreciated that the term ‘cryptographic keys’ is used herein a generic sense to mean any suitable cryptographic key, algorithm, or scheme to ensure the secure communication of data from one device to another. For example, the cryptographic keys may be based on the public-key cryptography system (asymmetric) or, alternatively an encryption system based on a symmetric algorithm such as ‘Triple DEA’. The precise form of cryptographic system is not intended to limit the scope of the present disclosure, and will be known to the skilled person, particularly those with knowledge of PCI DSS (Payment Card Industry Data Security Standard).

In a further alternative, instead of the mobile device and card reader device implementing two separate keys depending on the mode of operation, the digitization (or acceptance) service provider may perform the key selection depending on whether it is performing digitization of a physical card or whether it is carrying out a financial transaction relating to a digital card. For example, the mobile card reader may encrypt the data with a single cryptographic key for downstream decryption by the service provider. The service provider may then re-encrypt the transaction with a selected key which is dependent on the operational mode for transmission to third parties that are required to be able to receive the data.

The skilled person will appreciate that variations may be made of the specific embodiments discussed above without departing from the scope of the present disclosure as defined by the claims.

The above description is set in the context of payment cards that are configured with a magstripe for holding card data that is required for transactions. For the avoidance of doubt, it should be appreciated that the disclosure is not limited to data being held on, delivered or read from, magstripe cards, but also is applicable to data held on chip enabled cards. References in the above description to ‘magstripe data’ and the like shall therefore be construed as covering payment card data however it is stored, generated and initiated into a transaction.

1. A method of processing a transaction to enable an issuer of a physical transaction device to process a transaction message relating to a digital transaction device, wherein the digital transaction device is a digitized counterpart of the physical transaction device, the method comprising:
receiving transaction message data including a digital device data set associated with the digital transaction device;
identifying a physical device data set that corresponds to the digital device data set from a group of paired physical device data sets and respective digital device data sets stored in a database associated with a transaction processing system;
modifying the transaction message data to include the identified physical device data set to form a modified transaction message data; and
communicating the modified transaction message data to the issuer of the physical transaction device.

2. The method of claim 1, wherein, prior to receiving the transaction message data, the method further includes:
capturing a physical device data set;
communicating the physical device data set to the transaction processing system;
storing the physical device data set in the database; and
pairing the physical device data set with a corresponding digital device data set already stored in the database.

3. The method of claim 2, wherein capturing the physical device data set includes:
reading the physical device data set from the physical transaction device at a device reading apparatus; and
encrypting the physical device data set.

4. The method of claim 3, wherein encrypting the physical device data set occurs before communicating the physical device data set to the transaction processing system.

5. The method of claim 3, wherein encrypting the physical device data set includes selecting an encryption item from two or more different encryption items, and encrypting the physical device data set using the selected encryption items.

6. The method of claim 1, wherein modifying the transaction message data includes one of incorporating the physical device data set into the transaction message data with the digital device data set, incorporating the physical device data set into the transaction message data instead of the digital device data set, and incorporating the physical device data set into the transaction message data by overwriting the digital device data set.

7. (canceled)

8. (canceled)

9. The method of claim 1, wherein the physical transaction device is a payment card, and wherein the physical device data set includes the funding primary account number (FPAN) represented by the payment card.

10. The method of claim 9, wherein the digital transaction device is a digitized version of the payment card, and wherein the digital data set includes a digital primary account number (DPAN).

11. The method of claim 9, wherein the physical device data set is resident on a data storage unit on the payment card.

12. (canceled)

13. A system for processing a transaction to enable an issuer of a physical transaction device to process transaction message data relating to a digital transaction device, wherein the digital transaction device is a digitized counterpart of the physical transaction device, the system comprising a transaction processing system configured to:
receive transaction message data including a digital device data set associated with the digital transaction device;
identify a physical device data set that corresponds to the digital device data set from a group of paired physical device data sets and respective digital device data sets stored in a database associated with the transaction processing system;
modify the transaction message data to include the identified physical device data set to form modified transaction message data;
communicate the modified transaction message data to the issuer of the physical transaction device.

14. The system of claim 13, further including a device reading apparatus configured to:
read a data storage unit on the physical transaction device so as to capture the physical dataset stored therein; and
communicate the physical device data set to the transaction processing system, and wherein, in response, the transaction processing system is configured to:
store the received physical data set in the data set memory at the transaction processing system; and
pair the physical device data set with a corresponding digital device data set already stored in the data set memory.

15. The system of claim 14, wherein the device reading apparatus is further configured to encrypt the physical device data set.

16. The system of claim 15, wherein the device reading apparatus is removably engageable with a mobile telecommunications device, and wherein the device reading apparatus is configured to encrypt the physical device data set before communicating the physical device data set to the transaction processing system through the mobile telecommunications device.

17. The system of claim 15, wherein the device reading apparatus is configured to encrypt the physical device data set with a selected encryption item that is selected from a group of two or more different encryption items.

18. The system of claim 17, wherein the device reading apparatus includes a user interface configured to enable a user to select which of the two or more different encryption items is used to encrypt the physical device data set.

19. The system of claim 17, wherein the device reading apparatus includes a machine interface configured to interface with a computing device, and wherein the payment card reader is configured to allow selection of the two or more different encryption items for encrypting the physical device data set via the machine interface.

20. The system of claim 13, wherein the physical transaction device is a payment card, and wherein the physical device data set includes the funding primary account number (FPAN) represented by the payment card.

21. The system of claim 20, wherein the digital transaction device is a digitized version of the payment card, and wherein the digital data set includes a digital primary account number (DPAN).

22. (canceled)

23. A payment card reader comprising:
a receiving part for receiving a data storage unit of a payment card;
a data capture module configured to capture a physical card data set from the data storage unit of the payment card; and
a first encryption item and at least a second encryption item;
wherein, in a first mode of operation the payment card reader encrypts the captured physical card data using the first encryption item; and
wherein, in a second mode of operation the payment card reader encrypts the captured physical card data using the second encryption item.

24. The payment card reader of claim 23, further comprising a user interface configured to provide selection of the first or second modes of operation.

25. The payment card reader of claim 23, further comprising a machine interface configured to interface with a computing device, and wherein the payment card reader is configured to allow selection into the first or second modes of operation via the machine interface.

26. (canceled)
